(19) United States
(12) Patent Application Publication
(10) Pub. No.: US 2021/0377130 A1
(43) Pub. Date: Dec. 2, 2021

(54) MACHINE LEARNING BASED PREDICTIVE MODELING AND ANALYSIS OF TELECOMMUNICATIONS BROADBAND ACCESS IN UNSERVED AND UNDERSERVED LOCATIONS

(71) Applicant: Allen Tousi, Rockville, MD (US)

(72) Inventor: Allen Tousi, Rockville, MD (US)

(73) Assignee: Allen S. Tousi, Rockville, MD (US)

(21) Appl. No.: 17/404,296

(22) Filed: Aug. 17, 2021

(51) Int. Cl. H04L 12/24; G06Q 30/02

(52) U.S. Cl. CPC H04L 41/145; G06Q 30/0205; G06Q 30/0201

(57) ABSTRACT

A method, and corresponding system, employs machine learning to predict a plurality of output targets corresponding to a plurality of input attributes for nodes on a telecommunications network. Each node represents a user with no or limited Internet access desiring broadband communications. The target can be set to a measure of the likelihood of broadband access being provided for a particular node. The method and corresponding system includes steps and apparatus for: defining the attributes in relation to telecommunications broadband service for a node, each node having associated informational content; defining the targets as predictive outcomes relating to telecommunications broadband service for a node; assigning each attribute a value based on interpretation of informational content extracted from a node; determining targets corresponding to the attributes using a machine learning algorithm; and reporting the targets in response to queries. In an exemplary environment, a decision tree analysis is used, where each node is represented by a plurality of attributes, and each attribute is used to recursively effect a split of informational content pertaining to it, until a measure of gain as between the nodes is optimized. The target value for each node is thereby determined. The list of input attributes includes geographical factors, a socio-economic factors, political factors, educational factors, technology factors, external factors and telecommunications factors.

### CROSS-REFERENCE TO RELATED APPLICATIONS

There are no related applications.

### TECHNICAL FIELD

The technical field described herein relates generally to computer networks and data analysis, and more specifically to collection, training and predictive analysis of voluminous data.

### BACKGROUND

The Internet is actually a mid-twentieth century technology, its predecessor Arpanet having first deployed as early as 1969. But it was in the 1990s that privatization, via its release from the United States Depart of Commerce, fueled its spread and nearly geometrical progression into the early twenty-first century until today. As early as 1996, a first survey of Internet users showed 40 million, an impressive growth for a couple of years. But by 2013, the 2.5 billion mark was hit, and today, an astounding 4.7 billion of the world's 7.7 souls use the Internet, 61% of the world's entire population.

It would have been inconceivable before its spread to imagine the socio-economic growth the Internet would create and foster, and yet today, just as inconceivable to live without it, or for that matter, to overstate its impact. The digital market has grown to overshadow bricks and mortar, as digital advertising and sales, rapid and widespread growth, and economic collaboration and integrated communications have expanded regional reach to a global handshake. Concurrently, social media has expanded global human interaction on a scale heretofore unseen, broadening the size and concept of community, citizenry interaction with local and national governments, and indeed development of international relationships.

Vast economic opportunities on a scale heretofore unseen and unforeseen have been part of the inevitable Internet footprint. In its October, 2011 report, McKinsey Global Institute attributed to the Internet 3.4% of the gross domestic product (GDP) of the world's large economies, that themselves make up some 70% of the world's total GDP. By 2017, one conservative estimate found that 6.9% of U.S. gross domestic product (GDP), or $1.4 trillion dollars, was attributable to the digital economy.

But while growth and prosperity have gone hand-in-glove with access afforded by the Internet, a digital divide has left many behind. Pew Research found that by 2007, at 35% broadband connectivity, rural Americans trailed the overall population of all U.S. adults by a full 16%. In fact, Congress and local authorities have sought to resolve the disparity. By 2018, following Congress' Consolidated Appropriations Act, the U.S. Department of Agriculture's (USDA) had invested over $ 1 billion to expand broadband access to unserved rural areas as well as tribal lands. In 2019, $ 555 million was appropriated, followed by another $ 635 million in 2020.

Yet, despite vast spending to resolve the digital divide, progress has been slow. Despite that real gains have been made, a lag behind major metropolitan areas persists. In a 2019 survey, Pew Research found that while 63% of rural Americans had broadband access, they were still 12% behind the general populace.

Economic growth has been directly correlated to high-speed access. In its recent economic modeling analysis, Deloitte found a strong correlation between broadband access on the one hand, and GDP and job growth on the other. Its modeling found a 10% increase in access for year 2016 would have created 806,000 additional jobs in 2019, averaging 269,000 jobs annually. For 2014, the same increase would have generated 875,000 new jobs, and $ 186 billion dollar expansion of GDP.

The divide was only deepened by the global 2019 COVID-19 pandemic. Dry cleaners, restaurants and other local small businesses were severely impacted, but as the virus is not transmissible over electrons and photons on the information highway, the impact was far less severe for products purchased online or professional services rendered via Zoom. In fact, many firms capitalized on new opportunities brought about from a newly home-centered workforce, while companies with broad market power like Amazon, Google and Facebook expanded their reach and respective revenues.

The economics of bringing affordable access to less populated regions, or where household income lags behind the rest of the nation, is and remains an issue. But as noted, added dollars do not necessarily bring immediate or satisfactory results, and where tax dollars are at stake, in particular, it behooves legislators and their constituents to employ advances in technology to maximize the economic efficiency of such spending. Despite the relatively vast sums spent by government, it yet remains a challenge to predict key factors in both the qualitative and quantifiably measurable attributes of broadband access in the unserved and underserved communities based on known metrics.

### SUMMARY

An object of the embodiments is to substantially solve at least the problems and/or disadvantages discussed above, and to provide at least one or more of the advantages described below.

In exemplary embodiments, an inventive method employs machine learning to predict a plurality of targets corresponding to a plurality of attributes for nodes on a telecommunications network. In exemplary embodiments, each node represents a user with no or limited Internet access desiring broadband communications. The target can be set to a measure of the likelihood of broadband access being provided for a particular node.

An exemplary method includes: (i) defining the attributes in relation to telecommunications broadband service for a node, each node having a plurality of informational content associated with it; (ii) defining the targets as predictive outcomes relating to telecommunications broadband service for a node; (iii) assigning each attribute a value based on interpretation of an informational content extracted from a node; (iv) determining the targets corresponding to the attributes using a machine learning algorithm; and (v) reporting the targets in response to one or more queries.

In an exemplary implementation, step (iv) includes employing a decision tree analysis. Here, each node is represented by a plurality of the attributes; each attribute is used to recursively effect a split of informational content pertaining to it, until a measure of gain as between the nodes is optimized; and a target value for each node is determined. In one such implementation, measure of gain is defined as an increase in a measure of entropy as between the attributes of a node. In a first exemplary embodiment, the entropy is calculated as Σᵢ₌₁^{k}(Pᵢ Logₓ(Pᵢ), where P is the probability of the occurrence of an attribute, Logₓ is a logarithmic function having base x, and where i, k and x are integers. In another exemplary embodiment, the entropy is calculated as Σᵢ₌₁^{k}(PᵢSᵢ), where P is the probability of the occurrence of a said attribute and where S is the standard deviation measure of an attribute value.

In certain embodiments, the attributes include at least one of: a geographical factor; a socio-economic factor; a political factor; an educational factor; a technology factor; an external factor; and a telecommunications factor. Each of these factors can also include one or more additional factors defined by differing levels.

Exemplary factors at differing levels include: (a) where the geographical factor includes at least one of: Distance to Closest Major Metropolitan Area; Distance to Major Cities—Instate; Distance to Major Cities—Out-of-state; Distance to Canadian Border; Relationship to Immigration; Relationship to Commerce, Tourism; Distance to Mexican Border; Relative Urbanization Factors; Zoning Requirements; Planned Urban Development; Urban Sprawl and Traffic Patterns; (b) where the socio-economic factor includes at least one of: Median Household Income, including any one of By Comparison to U.S. Household Incomes, By Comparison to State Household Incomes, and By Comparison to Local Household Incomes; Household Disposable Income; Job Factors; Job Security; Local Plants; Local Plant Employment Opportunities; Household Purchase Behavior; Intergenerational Wealth Factors; and Social Mobility; (c) where the political factor includes at least one of: Political Party Affiliation; Civic Involvement; International Involvement; Statewide Involvement; and Relative factor, including any one of: Relative Federal Representation; Relative Statewide Representation; and Relative Township & Local Representation; (d) where the educational factor includes at least one of: Highest Education Earned; State Versus Private School Attendance; Graduate and College Level Education; High School and Grade School Level Education; Vicinity to Research; Vicinity to Private Research; Biomedical and Life Sciences Research; High Technology and Software Research; Vicinity to Institutions of Higher Learning; and Language and Ethnicity Factors; (e) where the technology factor includes at least one of: General Technology Adoption Rate; Broadband Adoption Rate; and Work Factors, comprising at least one of: Access for Work, Access for Primary Occupation; Access for Secondary/Additional Work; and Recreational and Gaming Access; (f) where the external factor includes at least one of: Federal Funding Per Household; State Funding Per Household; and Township & Local Funding Per Household; and (g) where the telecommunications factor includes at least one of: Profit-based Discrimination; State Level Competition; Local Level Competition; and Usage Scenarios, comprising any one of: HD Videoconferencing Access; 4K Access; and HD Access.

In additional exemplary embodiments, an inventive system and corresponding apparatus employ machine learning to predict a plurality of targets corresponding to a plurality of attributes for nodes on a telecommunications network. In exemplary embodiments of this implementation, each node represents a user with no or limited Internet access desiring broadband communications. Also, the target can be set to a measure of the likelihood of broadband access being provided for a particular node, and numerous other applications are enabled.

An exemplary such system includes: means for defining the attributes in relation to telecommunications broadband service for a node, each node having a plurality of informational content associated with it; means for defining the targets as predictive outcomes relating to the telecommunications broadband service for a node; means for assigning each attribute a value based on the interpretation of an informational content extracted from a node; means for determining the targets corresponding to the attributes using a machine learning algorithm; and means for reporting the targets in response to one or more queries.

In an exemplary implementation, the means for determining the targets includes employing a decision tree analysis. Each node is enabled to be represented by a plurality of the attributes; each attribute is used to recursively effect a split of informational content pertaining to it, until a measure of gain as between the nodes is optimized; and a target value for each node is determined. In one such implementation of the system, the measure of gain is defined as an increase in a measure of entropy as between the attributes of a node. In a first exemplary embodiment of the latter, the entropy is calculated as Σᵢ₌₁^{k}(Pᵢ Logₓ(Pᵢ), where P is the probability of the occurrence of a said attribute and where P is the probability of the occurrence of an attribute, Logₓ is a logarithmic function having base x, and where i, k and x are integers. In another exemplary embodiment, the entropy is calculated by the formula Σᵢ₌₁^{k}(PᵢSᵢ), where the variable S is the standard deviation measure of an attribute value.

In certain embodiments of the system and corresponding apparatus, the attributes include at least one of: a geographical factor; a socio-economic factor; a political factor; an educational factor; a technology factor; an external factor; and a telecommunications factor. Each of these factors can also include one or more additional factors defined by differing levels.

As with the method implementation, numerous factors at differing levels are enabled for implementation. Factors selected to exemplary embodiments at the differing levels include: (a) where the geographical factor includes at least one of: Distance to Closest Major Metropolitan Area; Distance to Major Cities—Instate; Distance to Major Cities—Out-of-state; Distance to Canadian Border; Relationship to Immigration; Relationship to Commerce, Tourism; Distance to Mexican Border; Relative Urbanization Factors; Zoning Requirements; Planned Urban Development; Urban Sprawl and Traffic Patterns; (b) where the socio-economic factor includes at least one of: Median Household Income, including any one of By Comparison to U.S. Household Incomes, By Comparison to State Household Incomes, and By Comparison to Local Household Incomes; Household Disposable Income; Job Factors; Job Security; Local Plants; Local Plant Employment Opportunities; Household Purchase Behavior; Intergenerational Wealth Factors; and Social Mobility; (c) where the political factor includes at least one of: Political Party Affiliation; Civic Involvement; International Involvement; Statewide Involvement; and Relative factor, including any one of: Relative Federal Representation; Relative Statewide Representation; and Relative Township & Local Representation; (d) where the educational factor includes at least one of: Highest Education Earned; State Versus Private School Attendance; Graduate and College Level Education; High School and Grade School Level Education; Vicinity to Research; Vicinity to Private Research; Biomedical and Life Sciences Research; High Technology and Software Research; Vicinity to Institutions of Higher Learning; and Language and Ethnicity Factors;

(e) where the technology factor includes at least one of: General Technology Adoption Rate; Broadband Adoption Rate; and Work Factors, comprising at least one of: Access for Work, Access for Primary Occupation; Access for Secondary/Additional Work; and Recreational and Gaming Access; (f) where the external factor includes at least one of: Federal Funding Per Household; State Funding Per Household; and Township & Local Funding Per Household; and (g) where the telecommunications factor includes at least one of: Profit-based Discrimination; State Level Competition; Local Level Competition; and Usage Scenarios, comprising any one of: HD Videoconferencing Access; 4K Access; and HD Access.

Additional principal features of the inventive embodiments will become apparent to persons skilled in the art upon review of the disclosed drawings, figures, description of the drawings, detailed description, claims and appendix.

### BRIEF DESCRIPTION OF THE DRAWINGS

The above and other objects and features of the embodiments will become apparent and more readily appreciated from the following description of the embodiments with reference to the following figures.

FIG. 1 illustrates a block diagram of a predictive processing component and corresponding components according to certain embodiments.

FIG. 2A illustrates exemplary geographical factors used as attributes, where certain factors are related to one another at multiple levels.

FIG. 2B illustrates exemplary socio-economic factors used as attributes, where certain factors are related to one another at multiple levels.

FIG. 2C illustrates exemplary political factors used as attributes, where certain factors are related to one another at multiple levels.

FIG. 2D illustrates exemplary educational factors used as attributes, where certain factors are related to one another at multiple levels.

FIG. 2E illustrates exemplary technological factors used as attributes, where certain factors are related to one another at multiple levels.

FIG. 2F illustrates exemplary external factors used as attributes, where certain factors are related to one another at multiple levels.

FIG. 2G illustrates exemplary telecommunications factors used as attributes, where certain factors are related to one another at multiple levels.

FIG. 3 illustrates the exemplary attribute of federal funding per household for a node, with amounts divided into three categories, according to an illustrative embodiment.

FIG. 4 illustrates the exemplary attribute of relative household income for a node, with amounts divided into three categories, according to an illustrative embodiment.

FIG. 5 illustrates the exemplary attribute of a distance to a major metropolitan area for a node, with amounts divided into three categories, according to an illustrative embodiment.

FIG. 6 illustrates an exemplary target attribute of the likelihood that a node will receive broadband access within a two-year timespan, according to an illustrative embodiment.

FIG. 7 illustrates an exemplary training data including attributes and targets, according to an illustrative embodiment.

FIG. 8 illustrates an exemplary decision tree including decision nodes and leaf nodes derived from the attributes and targets of FIG. 7, according to an illustrative embodiment.

FIG. 9 illustrates an exemplary process for running a predictive algorithm, according to an illustrative embodiment.

FIG. 10 illustrates an exemplary networking and telecommunications platform for the various embodiments.

FIG. 11 illustrates exemplary hardware and software platforms for the various embodiments.

### DETAILED DESCRIPTION

Introductory Considerations

The embodiments are described more fully hereinafter with reference to the accompanying drawings, in which embodiments of the inventive concept are shown. In the drawings, the size and relative sizes of layers and regions may be exaggerated for clarity.

Further, like numbers refer to like elements throughout the descriptions of the embodiments. The embodiments can, however, be embodied in numerous different manners and forms and should not be construed as limited to the embodiments set forth herein. Rather, the enclosed embodiments are provided so that this disclosure will be thorough and complete, and will fully convey the scope of the inventive concept to those skilled in the art.

The scope of the embodiments is therefore defined by the claims hereof and not to be narrowed based on the written description of said claims. The following embodiments are discussed, for simplicity, in regard to the structure and terminology of computers and one or more telecommunications networks, such as the Internet and other networks. However, the embodiments, as discussed below and hereinabove, are not limited to these systems but can be applied to any other fields of endeavor, and business activities and the like, among other applications.

Also, reference throughout the specification to “one embodiment” or “an embodiment” means that a particular feature, structure, or characteristic described in connection with an embodiment is included in at least one embodiment of the embodiments. Therefore, the appearance of the phrases “in one embodiment” or “in an embodiment” and similar language, in various places throughout the specification, is not necessarily referring to the same embodiment or otherwise to be considered as narrowing the enclosed embodiments. Further, the particular structures, features and characteristics can be combined in any suitable manner in one or more embodiments.

Further still, it should be apparent to those skilled in the relevant art that while certain items in the drawing Figures have been denoted “top,” “bottom,” “left side,” right side,” and the like, such spatial indicators are or can be arbitrary, and are done for the purposes of making it easier for the reader to understand and visualize the aspects of the embodiments and are not to be construed in a limiting manner.

Exemplary High Level Logical Architecture

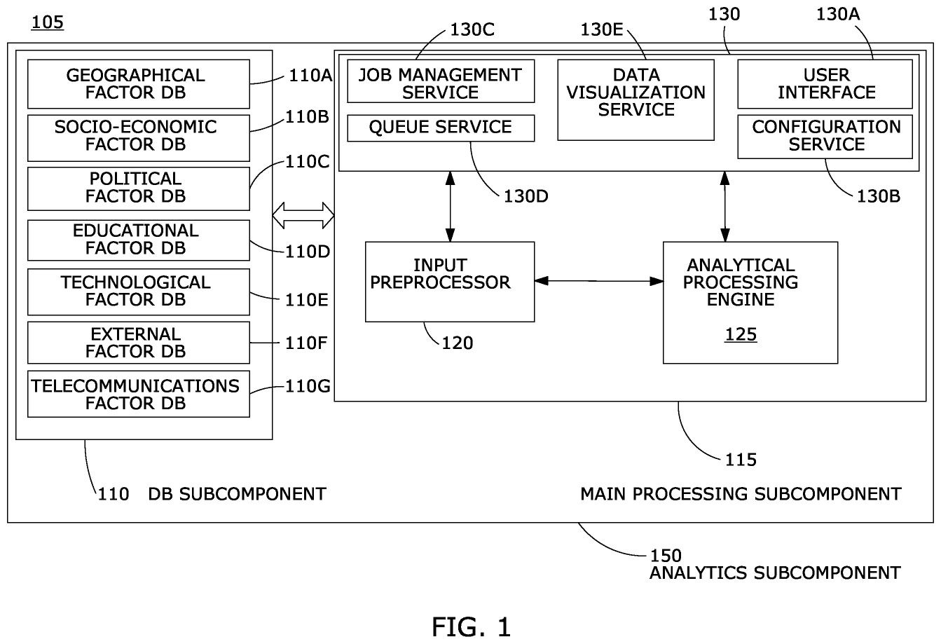

FIG. 1 illustrates exemplary predictive processing component 105. In particular is shown the analytics subcomponent 150 of the predictive processing component 105, whose features and functions have relevance to certain embodiments. In reference to analytics subcomponent 105, the subcomponent includes database (DB) subcomponent 110 and main processing subcomponent 115, which communicate through internal communications interface 155.

DB subcomponent 110 includes multiple databases (DBs) for storage of factors relevant to the present embodiments. Exemplary factor DBs include geographical factor DB 110a, socio-economic factor DB 110b, political factor DB 110c, education factor DB 110d, technological factor DB 110e, external factor DB 110f and telecommunications factor DB 110g.

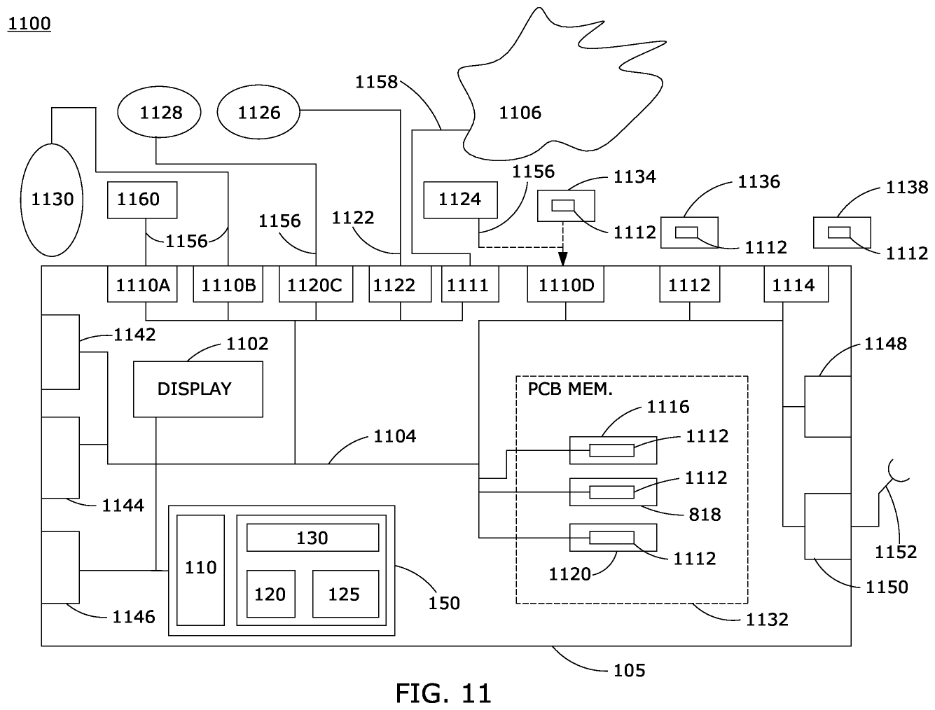

Main processing subcomponent 115, in turn, includes input preprocessor 120, application level processing engine 130 and analytical processing engine 125. Additional components and their respective functions of predictive processing component 105 are shown and explained below in reference to FIG. 11.

In reference to main processing subcomponent 115 and DB subcomponent 110, in exemplary embodiments, these and other such modules illustrated and described herein, comprise one or more processes implemented by software, hardware, whether resident or remote, such as in the cloud (i.e., to a group of computers, such as the Internet) or a combination of the same, though the inventive embodiments and are not to be taken as limited to such.

In particular, main processing subcomponent 115 includes application level processing engine 130 to support application level user interactions and to control such application function. As shown, in an exemplary embodiment application level processing engine 130 includes user interface 130a, configuration service 130b, job management service 130c, queue service 130d and visualization service 130e.

User interface 130a is adapted for user input and output, which permits any manner of known input. Components 130b-130e are adapted to control the application function. In the embodiment shown, configuration service 130b is adapted for setting and change of system parameters. Job management service 130c is adapted to control and manage jobs and batches. Queue service 130d is adapted for the queuing of new jobs. Also, data visualization service 130e supports presentation of data by way of visual display for relevant users. In certain embodiments, in combination, these components manage user interface configuration, reporting and analysis.

A number of the included functions for processing engine 130 are (i) permitting user assignment of business levels; (ii) configuring and consolidating data prepared for output to users via application programming interfaces (APIs); (iii) enabling user control and management of processor functions with respect to input data, via user interfaces in coordination with data from databases; (iv) auto-detecting prepared reports for visualization, and coordinating their presentation via output devices; (v) validating and implementing changes in configurations; (vi) running error analysis for configuration data; (vii) running archival processing and rollback in case of failures; (viii) managing sets of reports for review and analysis; and (ix) enabling users to build datasets for analytics and report functions.

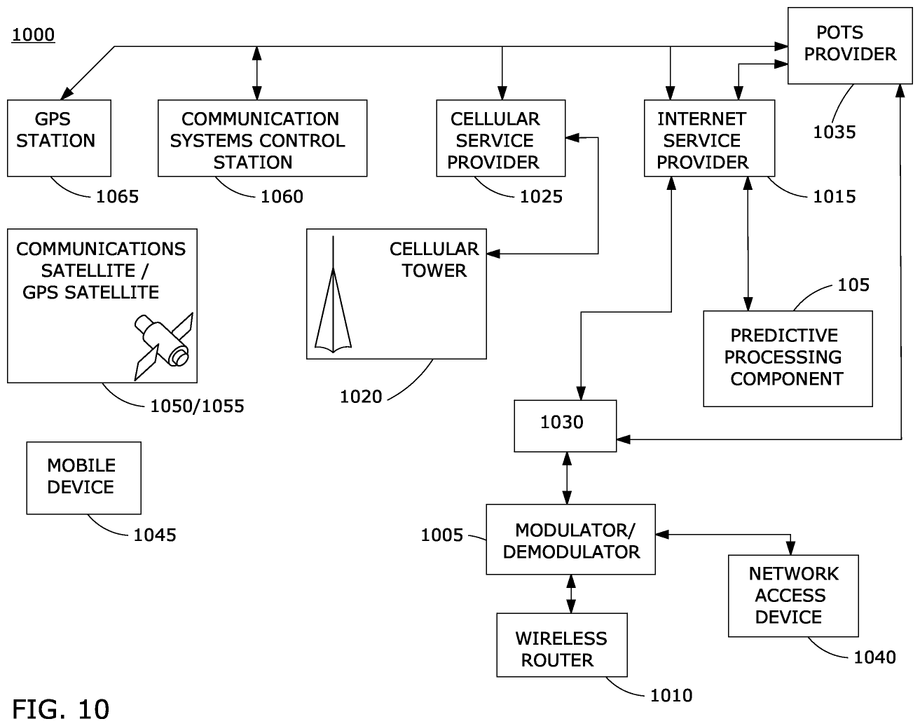

Input preprocessor 120 receives numerous inputs of data from DB subcomponent 110. In particular, in the illustrated embodiment, data related to nodes connected to a communications network 1000 (shown in FIG. 10) are provided. In certain embodiments, these nodes are not necessarily connected to other components of the network but may be adapted for connection and/or connected.

In certain such embodiments, these nodes are representative of households in the

United States with limited or no access to broadband telecommunications. Some of such nodes have no access to communications, while others have limited access but without broadband access. These nodes are implementation-specific, as any nodes and their respective representation are permissible according to the embodiments.

In the implementation shown, each node symbolically and/or logically corresponds to such an exemplary household. Geographical factor DB 110a includes factors relevant to the geography of the node. Socio-economic factor DB 110b includes factors relevant to the socio-economic conditions relevant to the node. Political factor DB 110c includes factors relevant to the political factors of the node. Education factor DB 110d includes factors relevant to the educational level of the node. Technological factor DB 110e includes factors relevant to the technological conditions relevant to the node. External factor DB 110f includes factors relevant to the additional conditions relevant to the node. And telecommunications factor DB 110g includes factors relevant to the telecommunications relevant to the node.

DBs 110a-110g are provided by way of understanding and are not to be taken as limiting of the embodiments to physical databases resident on analytics subcomponent 150. In implementation, there are no such restrictions in implementation, and in one implementation, the DBs are symbolic representations of data stored in the cloud.

In the exemplary embodiments, input preprocessor 120 prepares and handles a wide array of inputs from DBs 110a-100g in known formats, and prepares them for processing by analytical processing engine 125. Included as exemplary implementations of DBs 110 are a wide variety of data storage devices, resident or non-resident (such as in the cloud) with communication over element 155 via a bus, streaming interface, file transfer protocol (FTP), API, or a combination thereof, and other known interfaces, to analytical processing engine 125, which also includes a wide variety of implementational processes working in concert with memories. Examples include an Amazon S3 (Simple Storage Service) and an HDFS (Hadoop® Distributed Files System) and relational databases. The interface between input processor 120, analytical engine 125 and/or application level processing engine 130 (not shown) also includes the foregoing wide varieties of implementations. Similarly, the data transmitted or accessible at each such interface and processed internally is not limited to any particular format, as a wide array of formats (and preprocessing to other formats) are envisioned.

In one such embodiment, analytical processing engine 125, which in certain embodiments includes processors and memories, processes the data, and provides the processed data via data pipelines to an internal Hadoop Cluster (not labeled). In this implementation, the cluster is a collection of computers (i.e., nodes) networked in a coordinated parallel implementation for sets of voluminous data (i.e., big data). Here, the cluster nodes store and analyze mass amounts of data, in either structured or unstructured format, for a distributed computing environment. Batch and streaming processing of data is provided in an implementation for analysis and predictive processing. In an exemplary implementation, the cluster includes master and worker nodes, and has functionality for data and resource management, job scheduling and management, gateway services and core data processing.

Exemplary Relational Database Embodiment

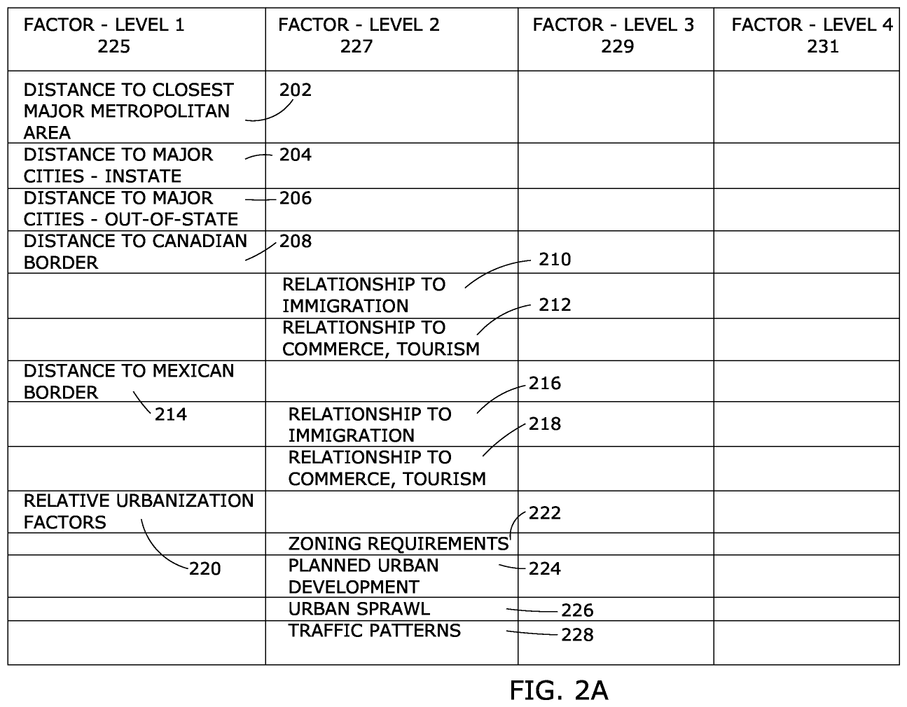

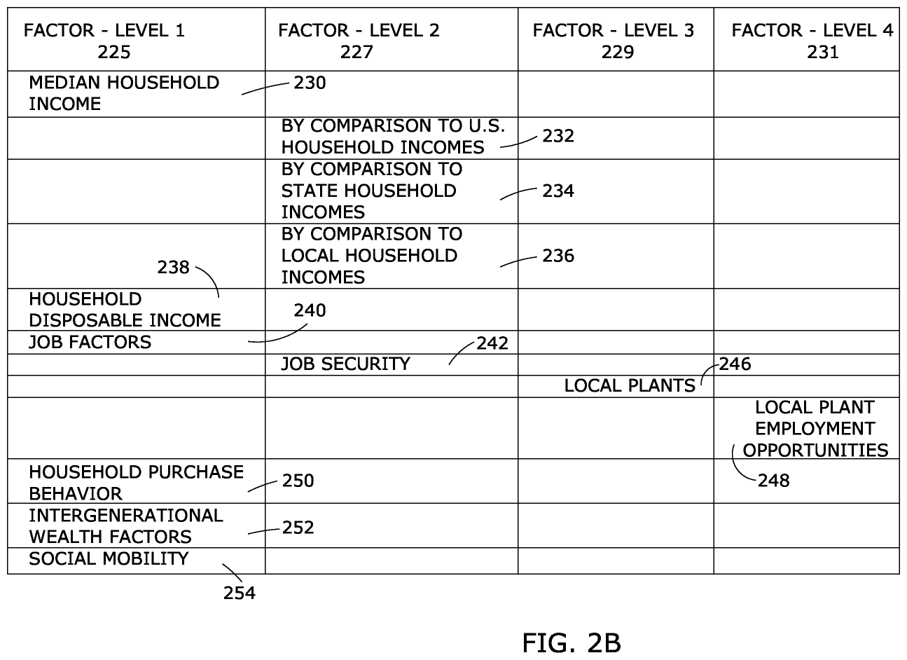

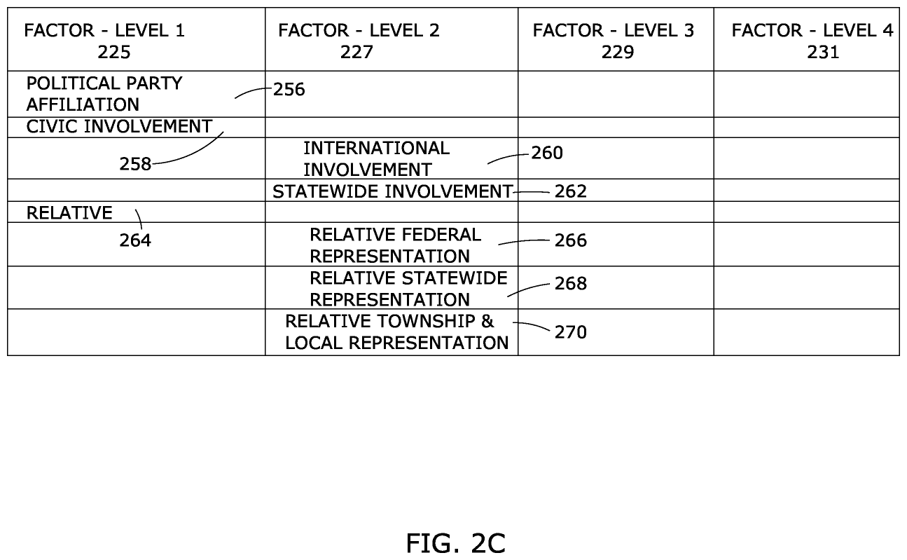

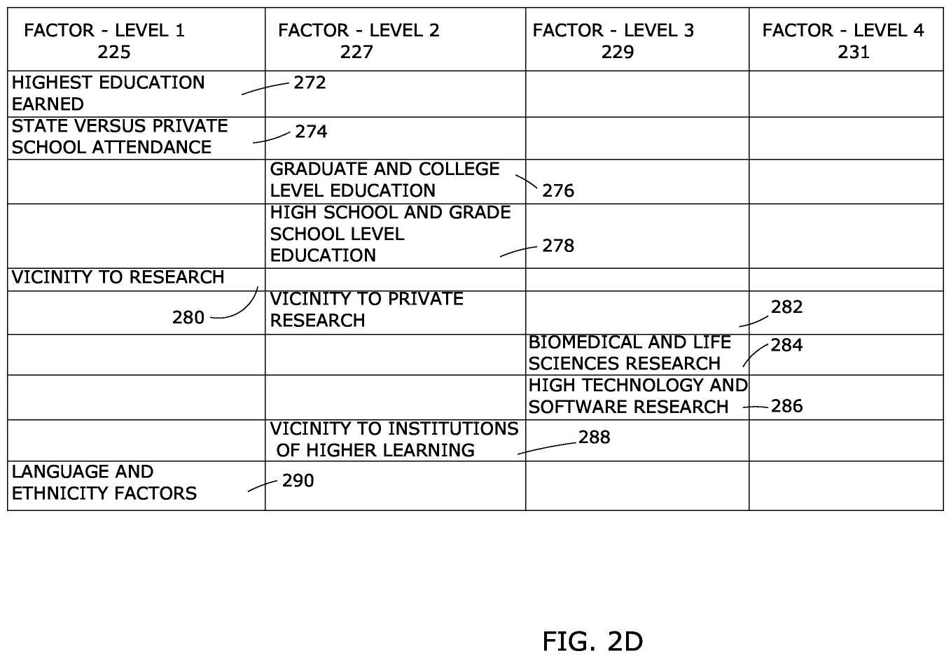

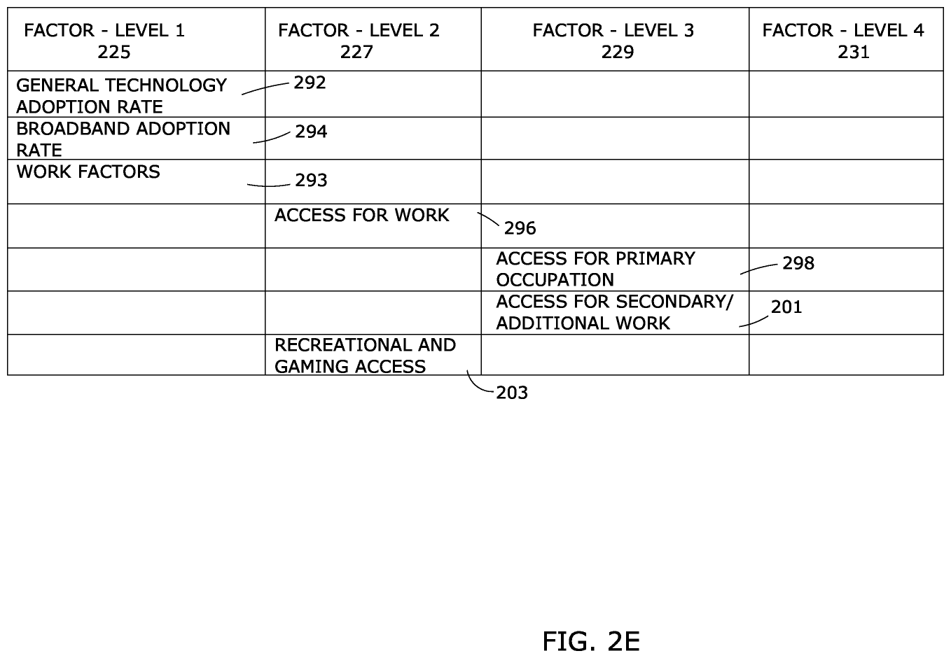

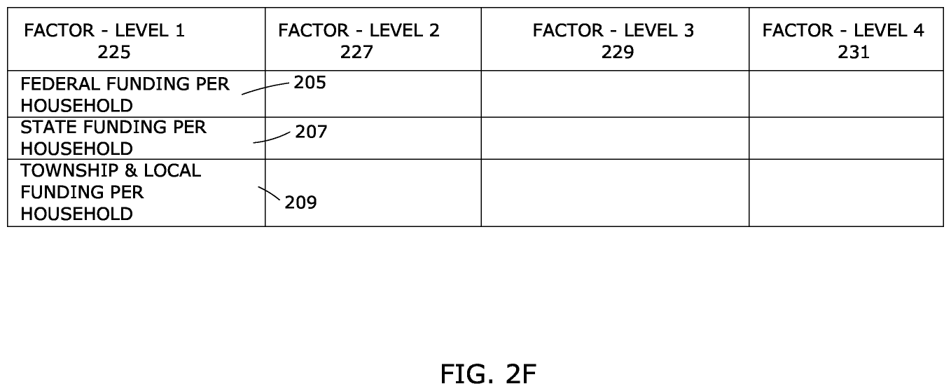

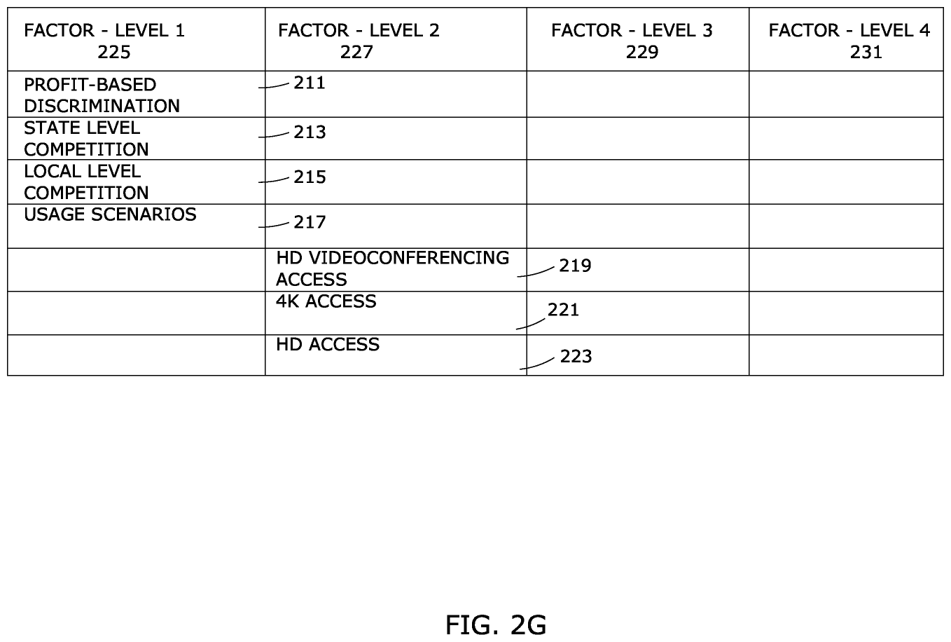

In exemplary embodiments, each of the factors of databases 110a-110g are comprised of multiple factors in relationships with one another. In one such embodiment, the factors are stored in one or more relational database memories, with the respective factors and subfactors being related to one another in differing levels. In certain implementations, the context is that of the aforementioned factors representative of nodes, wherein the nodes are representative of households in the United States with limited or no access to broadband telecommunications. Here, the factors relate to the nodes, and are at differing functional levels, where subfactors below a given level relate to the levels above them. FIGS. 2a-2g illustrate each such exemplary embodiment.

Beginning with FIG. 2a, the figure shows an exemplary relational model for the geographical factors of DB 110a for these exemplary embodiments. Factors at Level 1 225, Level 2 227, Level 3 229 and Level 4 231 are illustrated. The geographical factors of FIG. 2a as shown include, with respect to any given node, the Level 1 factors of the Distance to Closest Major Metropolitan Area 202, the Distance to Major Cities that are Instate 204, the Distance to Major Cities that are Out-of-state 206, the Distance to the Canadian Border 208, the Distance to the Mexican Border 214 and the Relative Urbanization Factors 220. In turn, the Level 1 factor 208 (the Distance to the Canadian Border) includes as subfactors Relationships to Immigration 210 and Relationships to Commerce and Tourism 212, which are characteristics of the node, or relationships thereof, which relate to factor 208. Similarly, the Distance to the Mexican border 214 includes subfactors Relationships to Immigration 216 and Relationships to Commerce and Tourism 218. Relative Urbanization Factors 220 include as subfactors, as applicable to the node or its characteristics, the factors of Zoning Requirements 222, Planned Urban Development (PUD) 224, Urban Sprawl 226 and Traffic Patterns 228.

Turning to FIG. 2b, the figure shows an exemplary relational model for the socio-economic factors of DB 110b for these exemplary embodiments. The geographical factors as shown include certain Level 1 factors, including the Median Household Income 230, including any one of By Comparison to U.S. Household Incomes 232, By Comparison to State Household Incomes 234, and By Comparison to Local Household Incomes 236 as Level 2 factors. Household Disposable Income 238 and Job Factors 240 are additional Level 1 factors. The latter Job factors 240 includes Job Security 242 as a Level 2 factor, which in turn includes Local Plants 246 as a Level 3 factor, which in turn includes Local Plant Employment Opportunities 248 as a Level 4 factor. Additional Level 1 factors are Household Purchase Behavior 250, Intergenerational Wealth Factors 252 and Social Mobility 254.

FIG. 2c shows an exemplary relational model for the political factors of DB 110c for these exemplary embodiments. The political factors as shown include certain Level 1 factors, namely Political Affiliation 256, Civic Involvement 258 and Relative factors 264. Level 1 factor Civic Involvement 258 includes subfactors International Involvement 260 and Statewide Involvement 262. Relative factors 264, in turn, include certain relative factors, including Relative Federal Representation 266, Relative Statewide Representation 268 and Relative Township & Local Representation 270.

FIG. 2d shows an exemplary relational model for the educational factors of DB 110d for these exemplary embodiments. The educational factors as shown include the Level 1 factors of Highest Education Earned 272, State Versus Private School Attendance 274, Vicinity to Research 280 and Language and Ethnicity Factors 290. The State Versus Private School Attendance factors 274 include as Level 2 subfactors Graduate and College Level Education 276, and High School and Grade School Level Education 278. The Vicinity to Research 280, a Level 1 factor, includes, as Level 2 subfactors Vicinity to Private Research 282, Biomedical and Life Sciences Research 284 and High Technology and Software Research 286. It also includes as a Level 2 factor Vicinity to Institutions of Higher Learning 288.

FIG. 2e shows an exemplary relational model for the technological factors of DB 110e for these exemplary embodiments. The technological factors as shown include the Level 1 factors of General Technology Adoption Rate 292, Broadband Adoption Rate 294 and Work Factors 293. The latter includes as Level 2 subfactors Access for Work 296 and Recreational and Gaming Access 203. In turn, Level 2 subfactor Access for Work 296 includes two subfactors at Level 3, namely Access for Primary Occupation 298 and Access for Secondary/Additional Work 201.

FIG. 2f shows an exemplary relational model for certain external factors of DB 110f for these exemplary embodiments. The external factors as shown include the Level 1 factors of Federal Funding Per Household 205, State Funding Per Household 207 and Township & Local Funding Per Household 209.

Lastly, FIG. 2g shows an exemplary relational model for certain telecommunications factors of DB 110g for these exemplary embodiments. The telecommunications factors as shown include the Level 1 factors Profit-based Discrimination 211, State Level Competition 213, Local Level Competition 215 and Usage Scenarios 217. The latter includes the Level 2 factors of HD Videoconferencing Access 219, 4K Access 221 and HD Access 223.

Exemplary Predictive Algorithm Embodiment

In exemplary implementations, analytical processing engine 125 employs a predictive algorithm by applying any of the foregoing factors and/or subfactors of FIGS. 2a-2g in an n-step sequential fashion to predict a target value. In these implementations, one or more of the factors is applied in a learning algorithm with training of the dataset with j points of data, where j is arbitrarily large, where target values are a measure of predictive outcome. In certain of these exemplary embodiments, the target outcome is the predictive measure of the likelihood that broadband access will be provided to a given node over a two-year span.

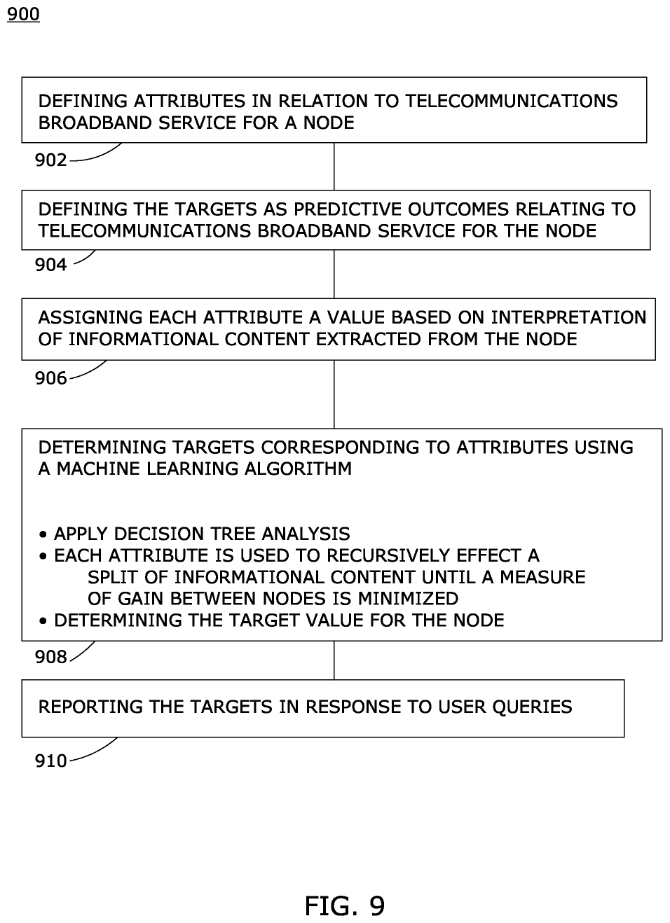

Turning to FIG. 9, a flowchart for an exemplary predictive algorithm according to the present embodiments is illustrated. In one such embodiment, the flowchart employs a decision tree regression algorithm.

In step 902, the attributes are defined and set accordingly. For the present application, the attributes are one or more of the aforementioned factors and/or subfactors (shown in FIGS. 2a-2g) to be applied in sequential fashion. In fact any of the factors may be used. The factors may also be used in any combination, including subfactors, to effect convergence of the trained set to high likelihood for predictive results.

In step 904, in the present application the target is defined as the relative likelihood that broadband access will be provided to the node in a period of two years. Here, the node relates to a household that does not presently have broadband access. A predictive determination is desired derived from a training set of data. The desire is to predict with high likelihood whether the household will receive its telecommunications access in the desired period, which presently has been set to a period of two years.

In step 906, the attributes, which are the above-defined factors presently, are assigned values. The values are used to distinguish between differing levels for a given attribute. The person running the model will experiment with given ranges to achieve preferred results. As noted, in an exemplary application, a decision tree analysis model is run, where each node is represented by a plurality of these attributes. Each attribute is then used to recursively effect a split of informational content. This is performed until a desired measure of gain as between attributes is optimized. As a general measure, it is preferred that the entropy differential be highest for the first attribute, meaning for the first split, and that the entropy differential be decreased accordingly for subsequent splits until the split is applied for the last attribute.

Gain references the information gain, and in exemplary embodiments, refers to the measure of decrease in entropy after the dataset is split for a given attribute. In an exemplary embodiment, the entropy is calculated as the summation Σᵢ₌₁^{k}(Pᵢ Logₓ(Pᵢ), where P is the probability of the occurrence of an attribute, Logₓ is a logarithmic function having base x, and where i, k and x are integers. Also, in one exemplary embodiment, the entropy is calculated as Σᵢ₌₁^{k}(PᵢSᵢ), where P is the probability of the occurrence of an attribute and S is the standard deviation measure of the attribute value.

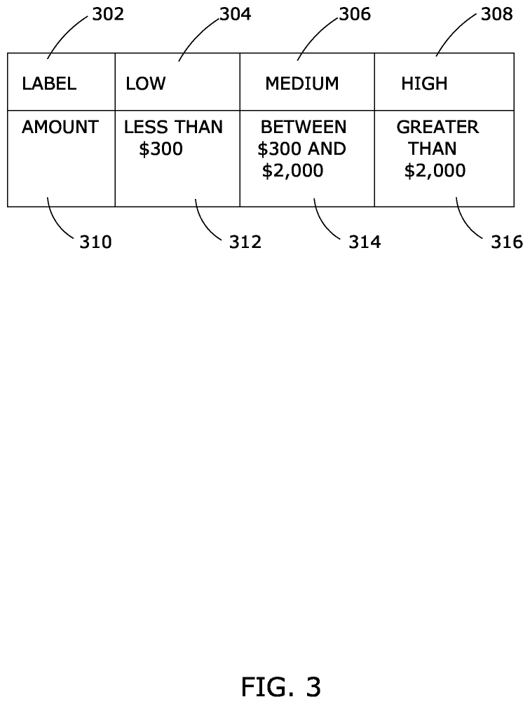

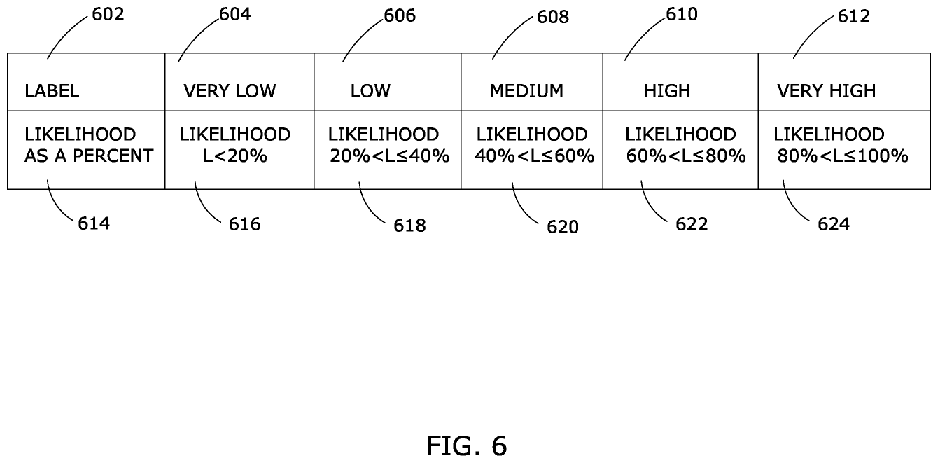

FIGS. 3-8 illustrate an exemplary implementation of the decision tree analysis from given sets of data relating to the nodes. In reference to FIG. 3, the federal funding received per household is set. Here, the amounts are set in row 310, namely as less than $300 at 312, between $300 and $2000 at 314 and at greater than $2000 at 316. The measures are labeled for the analysis (302) as LOW at 304, MEDIUM at 306 and HIGH at 308.

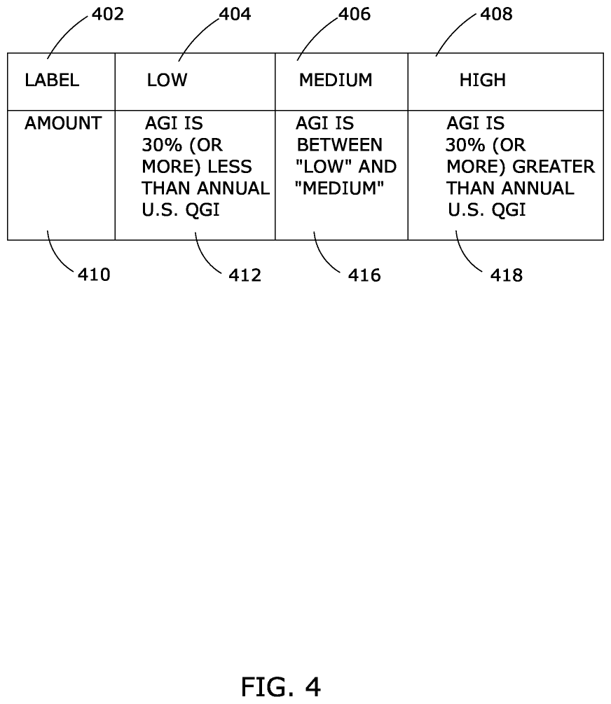

A second factor asserted as an attribute is the household income for a given node. In reference to FIG. 4, the relative household income measure is used. To quantify the results, in this model, the gross income of the household is compared to the maximum qualifying gross income, the latter being experimentally set to the gross income for micro entities for inventors by the USPTO. The amounts are set in row 410, namely by comparing the gross income to the qualifying gross income, and determining the difference as thirty percent (or less) at 412, as thirty percent (or more) greater at 418, or as between these two measures at 416. The measures are labeled for the analysis (402) as LOW at 404, MEDIUM at 406 and HIGH at 408.

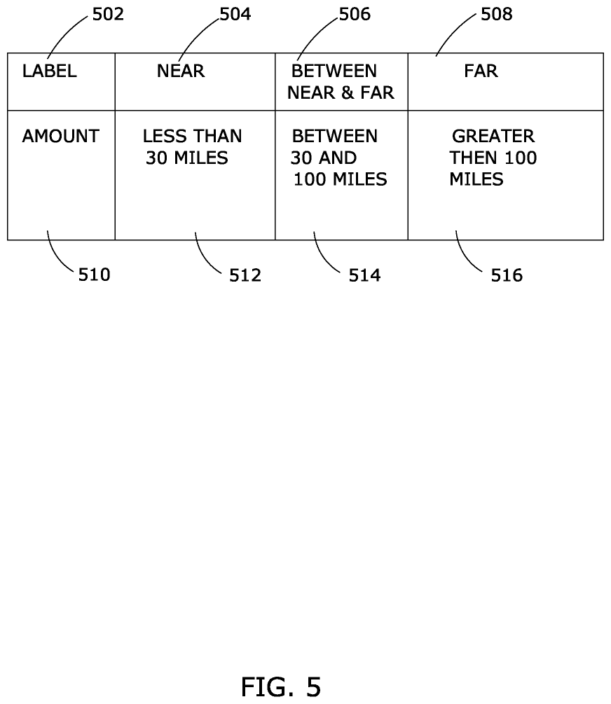

Similarly, a third factor asserted as an attribute in the present modeling is the distance to a metropolitan area of a given node. In reference to FIG. 5, a determination in miles is used. To quantify the results, in this model, the amounts are set in row 510, namely by providing a measure of less than thirty miles from the nearest metropolitan area at 512, at between 30 miles and 100 miles at 514, and greater than 100 miles at 516. The measures are labeled for the analysis (502) as NEAR at 504, BETWEEN NEAR & FAR at 506 and FAR at 508.

In the preliminary analysis, the above standard deviation is applied, and standard deviation reduction is measured to ascertain splits following running the recursive algorithm for each attribute. Here, it is determined that the highest entropy gain is for the federal funding received attribute, followed by household income, and lastly, for distance to a major city. Accordingly, the above second decision-tree regression entropy formula is recursively applied, first to the measure of federal funding received, followed by the measure of household income, and lastly for the measure of distance to the nearest metropolitan area.

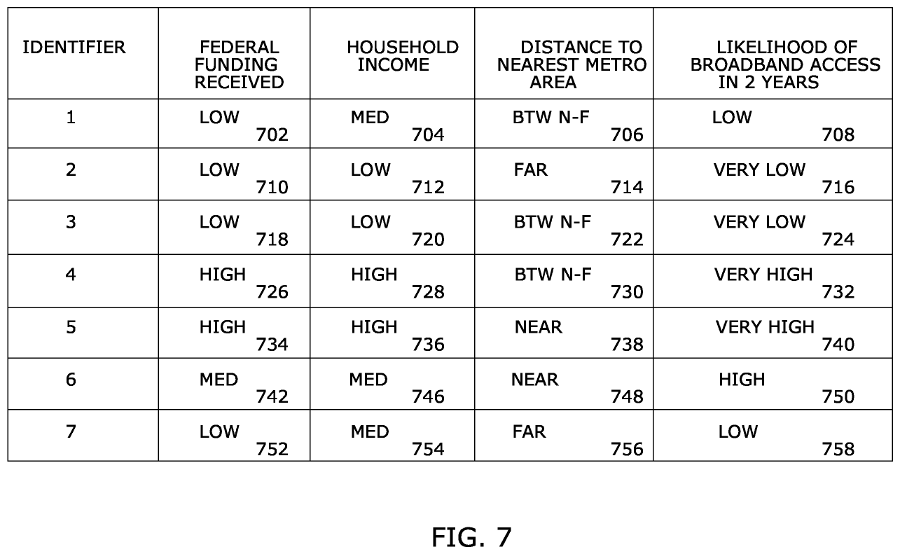

FIG. 7 shows the application. Each of attributes federal funding, household income and distance to the nearest metropolitan area are shown for the exemplary node data identified on the left. For instance, for row 1 and the node identified as 1, the federal funding received is LOW (702), the household income is MED (for MEDIUM) (704), and the distance to the nearest metropolitan area is BTW N-F (meaning BETWEEN NEAR & FAR) (706). The target, namely the likelihood of broadband access within the period of two years, is shown in the last column. For this node 1, the value is LOW (708). The remaining rows for identified nodes 2-7 are shown in FIG. 7, and as they are self-explanatory, are not further described here.

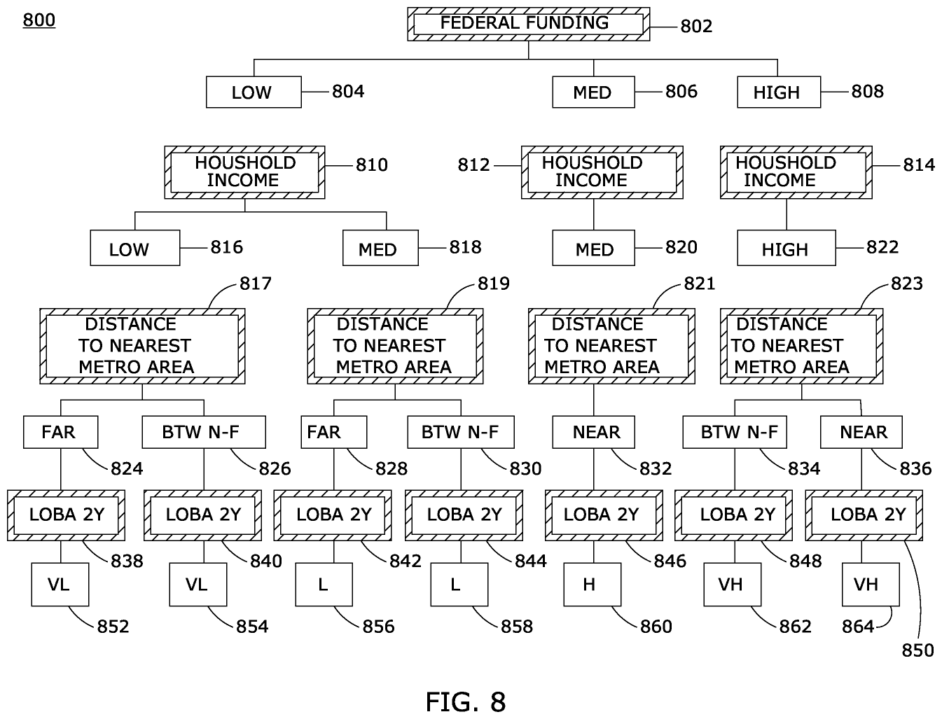

FIG. 8 shows the decision tree of the recursive algorithm for the same nodes identified in FIG. 7. Specifically, the decision tree shows leaf nodes at the bottom of the tree, with decision nodes for the attributes above it. For instance, the decision nodes of federal funding 802, household income 810-814 and distance to nearest metropolitan area 817-823 as well as for the likelihood of broad access in 2 years (labeled LOBA 2Y) 838-850 are shown. The leaf nodes 852-864 for the target are shown at the bottom.

By way of example, for the same node identified as 1 in FIG. 7 (from row 1), the split following federal funding (802) yields a LOW (804), followed by a split for household income (810) yielding a MED (818), followed by a split for distance to major metropolitan area (819) yielding a BTW N-F (830) and the result is LOBA 2Y (844) at a value of L, for LOW (858). The remaining values for nodes identified as 2-7 are shown in FIG. 8. As the results are illustrated and self-explanatory based on the foregoing methods, they are not further described here.

Exemplary Network Embodiments

FIG. 10 illustrates exemplary network (NW) 1000 for communications between relevant platforms, channels, applications and other elements according to certain embodiments. Predictive processing component 105 (as shown in FIG. 1) is illustrated as being a component of and connecting with additional components of the network.

Skilled persons will recognize components of network 1000 as shown in FIG. 10, and for the purpose of clarity and brevity, a discussion thereof is omitted. In network 1000, the user has mobile device 1045, which can access cellular service provider 1025, either through a wireless connection (e.g., cellular tower 1020) or via a wireless/wired interconnection (a “Wi-Fi” system that comprises, e.g., modulator/demodulator (modem) 1030, wireless router 1010, network access device 1040, internet service provider (ISP) 1015, and network 1030).

Further, mobile device 1045 can include near field communication (NFC), “Wi-Fi,” and Bluetooth (BT) communications capabilities as well, all of which are known to those of skill in the art. To that end, network 1000 further includes, as many homes (and businesses) do, one or more network access devices 1040 that can be connected to wireless router 1010 via a wired connection (e.g., modem 1030) or via a wireless connection (e.g., Bluetooth).

Modem 1030 can be connected to ISP 1015 to provide Internet-based communications in the appropriate format to end users (e.g., network access device 1040), and which takes signals from the end users and forwards them to ISP 1015. Such communication pathways are well known and understand by those of skill in the art, and a further detailed discussion thereof is therefore unnecessary.

Mobile device 1045 can also access global positioning system (GPS) satellite 1055, which is controlled by GPS station 1065, to obtain positioning information (which can be useful for different aspects of the embodiments), or mobile device 1045 can obtain positioning information via cellular service provider 1025 using cell tower(s) 1020 according to one or more well-known methods of position determination.

Certain mobile devices 1045 can also access communication satellites 1050 and their respective satellite communication systems control stations 1060 (the satellite in FIG. 10 is shown common to both communications and GPS functions) for near-universal communications capabilities, albeit at a much higher cost than convention “terrestrial” cellular services. Mobile device 1045 can also obtain positioning information when near or internal to a building (or arena/stadium) through the use of one or more of NFC/BT devices, the details of which are known to those of skill in the art. FIG. 10 also illustrates other components of network system 1000 such as plain old telephone service (POTS) provider 1035.

According to additional aspects of the embodiments, network 1000 also contains predictive processing component 105, where one or more processors, using known and understood technology, such as memory, data and instruction buses, and other electronic devices, can store and implement code that can implement the aforementioned systems and methods.

An encoding process can also be employed with certain embodiments. The encoding process is not meant to limit the aspects of the embodiments, or to suggest that the aspects of the embodiments should be implemented following the encoding process.

In exemplary embodiments, a source array, computer software, and methods are employed for conducting the operations of predictive processing component 105. It should be understood that these descriptions are not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments can be practiced without such specific details.

Exemplary Hardware/Software Embodiments

FIG. 11 illustrates an exemplary hardware and software embodiment 1100. The embodiment serves to show the interoperability of hardware and software components of exemplary predictive processing component 105 (also shown in FIG. 1) and its interconnectivity with additional components.

Predictive processing component 105 includes, among other items, analytics subcomponent 150 (including its databases and processor subcomponents, as shown in FIG. 1), internal data/command bus (bus) 1104, additional processor(s) (not shown) (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 1110, compact disk (CD)/digital video disk (DVD) read/write (R/W) drives 1112, floppy diskette drive 1114 (though less used currently, many servers still include this device), and data storage unit 1132.

According to further aspects of the embodiments, a controller can be used in place or, or in conjunction with a processor, wherein the controller can include one or more hardware components designed and/or fabricated to replicate the functionality of the processor. According to still further aspects of the embodiments, processors and controllers can be used interchangeably or in combination to perform the processing functions described herein.

Data storage unit 1132 itself can comprise hard disk drive (HDD) 1116 (these can include conventional magnetic storage media, but, as is becoming increasingly more prevalent, can include flash drive-type mass storage devices 1134, among other types), read-only memory (ROM) device(s) 1118 (these can include electrically erasable (EE) programmable ROM (EEPROM) devices, ultra-violet erasable PROM devices (UVPROMs), among other types), and random access memory (RAM) devices 1120. Usable with USB port 1110 is flash drive device 1134, and usable with CD/DVD R/W device 1112 are CD/DVD disks 1136 (which can be both read and write-able). Usable with floppy diskette drive device 1114 are floppy diskettes 1138. Each of the memory storage devices, or the memory storage media (1116, 1118, 1120, 1134, 1136, and 1138, among other types), can contain parts or components, or in its entirety, executable software programming code or application (application, or “App”) analytics apps, which can implement part or all of the portions of method 500 described herein. Further, a processor (e.g., analytics subcomponent 150, or a processor component thereof) itself can contain one or different types of memory storage devices (most probably, but not in a limiting manner, RAM memory storage media 1120) that can store all or some of the components of the analytics app. These components can be used with, in place of, or in combination with analytics subcomponent 150.

In addition to the above described components, predictive processing component 105 also includes user console 1124, which can include keyboard 1128, display 1126, and mouse 1130. All of these components are known to those of ordinary skill in the art, and this description includes all known and future variants of these types of devices. Display 1126 can be any type of known display or presentation screen, such as liquid crystal displays (LCDs), light emitting diode displays (LEDs), plasma displays, cathode ray tubes (CRTs), among others. User console 1124 can include one or more user interface mechanisms such as a mouse, keyboard, microphone, touch pad, touch screen, voice-recognition system, among other inter-active inter-communicative devices.

User console 1124, and its components if separately provided, interface with predictive processing component 105 via server input/output (I/O) interface 1122, which can be an RS232, Ethernet, USB or other type of communications port, or can include all or some of these, and further includes any other type of communications means, presently known or further developed. Predictive processing component 105 can further include communications satellite/global positioning system (satellite) transceiver device 1150 to which is electrically connected at least one antenna 1152 (according to an embodiment, there can be at least one GPS receive-only antenna, and at least one separate satellite bi-directional communications antenna). Predictive processing component 105 can access the Internet, either through a hard-wired connection, via I/O interface 1122 directly, or wirelessly via Wi-Fi transceiver 1142, 3G/4G transceiver 1148 and/or satellite transceiver device 1150 (and their respective antennas) according to an embodiment. Predictive processing component 105 can also be part of a larger network configuration as in a global area network (GAN) (e.g., the Internet), which ultimately allows connection to various landlines.

According to further embodiments, user console 1124 provides a means for personnel to enter commands and configuration into predictive processing component 105 (e.g., via a keyboard, buttons, switches, touch screen and/or joystick). Display device 1126 can be used to show visual representations of acquired data, and the status of applications that can be running, among other things.

Bus 1104 provides a data/command pathway for items such as: the transfer and storage of data/commands between a processor (e.g., analytics subcomponent 150, or processor components thereof), Wi-Fi transceiver 1142, BT transceiver 1144, NFC transceiver 1146, internal display 1102, I/O port 1122, USB port 1110, CD/DVD drive 1112, floppy diskette drive 1114, memory 1132, 3G/4G transceiver 1148 and satellite transceiver device 1150. Through bus 1104, data can be accessed that is stored in data storage unit memory 1132. The processor can send information for visual display to display 1126, and the user can send commands to system operating programs/software/Apps that might reside in a processor.

Predictive processing component 105 includes subcomponent 150 (shown in FIG. 1), which in turn includes one or more memories (whose subcomponent databases 110 are shown in FIG. 1), and can be used to implement the inventive methods for modeling interaction between an individual and an entity according to aspects of the embodiments. Hardware, firmware, software or a combination thereof can be used to perform the various steps and operations described herein. According to an embodiment, apps for carrying out the above discussed steps can be stored and distributed on multi-media storage devices such as devices 1116, 1118, 1120, 1134, 1136 and/or 1138 (described above) or other form of media capable of portably storing information, and storage media 1134, 1136 and/or 1138 can be inserted into, and read by, devices such as USB port 1110, CD-ROM drive 1112, and disk drives 1114, 1116, among other types of software storage devices.

As also will be appreciated by one skilled in the art, the various functional aspects of the embodiments can be embodied in any combination of channels, protocols, platforms or technologies. Accordingly, the embodiments can take the form of an entirely hardware embodiment or an embodiment combining hardware and software aspects. Further, the embodiments can take the form of a non-transitory computer program product stored on a computer-readable storage medium having computer-readable instructions embodied in the medium. Any suitable computer-readable medium can be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable, volatile/nonvolatile, and transitory/non-transitory computer storage media. For example, the processor can access a hard disk drive that reads from or writes to non-removable, nonvolatile, and non-transitory magnetic media, a magnetic disk drive that reads from or writes to a removable, nonvolatile, and non-transitory magnetic disk, and/or an optical disk drive that reads from or writes to a removable, nonvolatile, and non-transitory optical disk, such as a CD-ROM or other optical media. Other removable/non-removable, volatile/nonvolatile, and non-transitory computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

Non-Limiting Nature of Described Embodiments

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

We claim:

1. A method for employing machine learning to predict a plurality of targets corresponding to a plurality of attributes for nodes on a telecommunications network, the method comprising:
(i) defining the attributes in relation to telecommunications broadband service for a said node, each said node having a plurality of informational content associated therewith;
(ii) defining the targets as predictive outcomes relating to said telecommunications broadband service for a said node;
(iii) assigning each said attribute a value based on interpretation of a said informational content extracted from a said node;
(iv) determining said targets corresponding to said attributes using a machine learning algorithm; and
(v) reporting said targets in response to one or more queries.

2. A method according to claim 1, wherein step (iv) comprises employing a decision tree analysis, wherein:
each said node is represented by a plurality of said attributes;
each said attribute is used to recursively effect a split of informational content pertaining thereto, until a measure of gain as between the nodes is optimized; and
determining a target value for each said node.

3. A method according to claim 2, wherein said measure of gain is defined as an increase in a measure of entropy as between the attributes of a said node.

4. A method according to claim 3, wherein the entropy is calculated as
$${\sum }_{i = 1}^{k} ( {P}_{i} {Log}_{x} ( {P}_{i} )$$
wherein P is the probability of the occurrence of a said attribute, Logₓ is a logarithmic function having base x, and where i, k and x are integers.

5. A method according to claim 3, wherein the entropy is calculated as Σᵢ₌₁^{k}(PᵢSᵢ), where P is the probability of the occurrence of a said attribute and where S is the standard deviation measure of a said attribute value.

6. A method according to claim 1, wherein said attributes comprise at least one of:
a geographical factor;
a socio-economic factor;
a political factor;
an educational factor;
a technology factor;
an external factor; and
a telecommunications factor.

7. A method according to claim 6, wherein each said factor comprises one or more additional factors defined by differing levels.

8. A method according to claim 7, wherein:
said geographical factor comprises at least one of: Distance to Closest Major Metropolitan Area; Distance to Major Cities—Instate; Distance to Major Cities—Out-of-state; Distance to Canadian Border; Relationship to Immigration; Relationship to Commerce, Tourism; Distance to Mexican Border; Relative Urbanization Factors; Zoning Requirements; Planned Urban Development; Urban Sprawl and Traffic Patterns;
said socio-economic factor comprises at least one of: Median Household Income, including any one of By Comparison to U.S. Household Incomes, By Comparison to State Household Incomes, and By Comparison to Local Household Incomes; Household Disposable Income; Job Factors; Job Security; Local Plants; Local Plant Employment Opportunities; Household Purchase Behavior; Intergenerational Wealth Factors; and Social Mobility;
said political factor comprises at least one of: Political Party Affiliation; Civic Involvement; International Involvement; Statewide Involvement; and Relative factor, including any one of: Relative Federal Representation; Relative Statewide Representation; and Relative Township & Local Representation;
said educational factor comprises at least one of: Highest Education Earned; State Versus Private School Attendance; Graduate and College Level Education; High School and Grade School Level Education; Vicinity to Research; Vicinity to Private Research; Biomedical and Life Sciences Research; High Technology and Software Research; Vicinity to Institutions of Higher Learning; and Language and Ethnicity Factors;
said technology factor comprises at least one of: General Technology Adoption Rate; Broadband Adoption Rate; and Work Factors, comprising at least one of: Access for Work, Access for Primary Occupation; Access for Secondary/Additional Work; and Recreational and Gaming Access;
said external factor comprises at least one of: Federal Funding Per Household; State Funding Per Household; and Township & Local Funding Per Household; and
said telecommunications factor comprises at least one of: Profit-based Discrimination; State Level Competition; Local Level Competition; and Usage Scenarios, comprising any one of: HD Videoconferencing Access; 4K Access; and HD Access.

9. A method according to claim 1, wherein the target is a measure of the likelihood of broadband access being provided for a said node.

10. A system for employing machine learning to predict a plurality of targets corresponding to a plurality of attributes for nodes on a telecommunications network, the system comprising:
means for defining the attributes in relation to telecommunications broadband service for a said node, each said node having a plurality of informational content associated therewith;
means for defining the targets as predictive outcomes relating to said telecommunications broadband service for a said node;
means for assigning each said attribute a value based on interpretation of a said informational content extracted from a said node;
means for determining said targets corresponding to said attributes using a machine learning algorithm; and
(v) means for reporting said targets in response to one or more queries.

11. A system according to claim 10, wherein the means for determining said targets comprises employing a decision tree analysis, wherein:
each said node is represented by a plurality of said attributes;
each said attribute is used to recursively effect a split of informational content pertaining thereto, until a measure of gain as between the nodes is optimized; and
determining a target value for each said node.

12. A system according to claim 11, wherein said measure of gain is defined as an increase in a measure of entropy as between the attributes of a said node.

13. A system according to claim 12, wherein the entropy is calculated as
$${\sum }_{i = 1}^{k} ( {P}_{i} {Log}_{x} ( {P}_{i} )$$
wherein P is the probability of the occurrence of a said attribute, Logₓ is a logarithmic function having base x, and where i, k and x are integers.

14. A system according to claim 12, wherein the entropy is calculated as Σᵢ₌₁^{k}(PᵢSᵢ), where P is the probability of the occurrence of a said attribute and where S is the standard deviation measure of a said attribute value.

15. A system according to claim 10, wherein said attributes comprise at least one of:
a geographical factor;
a socio-economic factor;
a political factor;
an educational factor;
a technology factor;
an external factor; and
a telecommunications factor.

16. A system according to claim 15, wherein each said factor comprises one or more additional factors defined by differing levels.

17. A system according to claim 16, wherein:
said geographical factor comprises at least one of: Distance to Closest Major Metropolitan Area; Distance to Major Cities—Instate; Distance to Major Cities—Out-of-state; Distance to Canadian Border; Relationship to Immigration; Relationship to Commerce, Tourism; Distance to Mexican Border; Relative Urbanization Factors; Zoning Requirements; Planned Urban Development; Urban Sprawl and Traffic Patterns;
said socio-economic factor comprises at least one of: Median Household Income, including any one of By Comparison to U.S. Household Incomes, By Comparison to State Household Incomes, and By Comparison to Local Household Incomes; Household Disposable Income; Job Factors; Job Security; Local Plants; Local Plant Employment Opportunities; Household Purchase Behavior; Intergenerational Wealth Factors; and Social Mobility;
said political factor comprises at least one of: Political Party Affiliation; Civic Involvement; International Involvement; Statewide Involvement; and Relative factor, including any one of: Relative Federal Representation; Relative Statewide Representation; and Relative Township & Local Representation;
said educational factor comprises at least one of: Highest Education Earned; State Versus Private School Attendance; Graduate and College Level Education; High School and Grade School Level Education; Vicinity to Research; Vicinity to Private Research; Biomedical and Life Sciences Research; High Technology and Software Research; Vicinity to Institutions of Higher Learning; and Language and Ethnicity Factors;
said technology factor comprises at least one of: General Technology Adoption Rate; Broadband Adoption Rate; and Work Factors, comprising at least one of: Access for Work, Access for Primary Occupation; Access for Secondary/Additional Work; and Recreational and Gaming Access;
said external factor comprises at least one of: Federal Funding Per Household; State Funding Per Household; and Township & Local Funding Per Household; and
said telecommunications factor comprises at least one of: Profit-based Discrimination; State Level Competition; Local Level Competition; and Usage Scenarios, comprising any one of: HD Videoconferencing Access; 4K Access; and HD Access.

18. A system according to claim 10, wherein the target is a measure of the likelihood of broadband access being provided for a said node.
